(19) United States
(12) Patent Application Publication
(10) Pub. No.: US 2011/0281079 A1
(43) Pub. Date: Nov. 17, 2011

(54) Double-Faced tape

(76) Inventor: Jin S. Kim, Las Vegas, NV (US)

(21) Appl. No.: 12/800,283

(22) Filed: May 11, 2010

(51) Int. Cl. B32B 3/00

(52) U.S. Cl. 428/172

(57) ABSTRACT

Double-faced masking tape having two areas on each side, one area on each side being coated with adhesive and opposite a non-adhesive non-stick area on the other side and the other non-adhesive area on each side opposite an area coated with adhesive on the other side, the two areas on each side being separated by a non-adhesive gap having a width of approximately ⅛″ to 3″.

### FIELD OF THE INVENTION

The present invention relates generally to masking tape, in particular to double-faced masking tape useful for applications including but not limited to painting.

### BACKGROUND OF THE INVENTION

Masking tape has long been a staple tool for painters. One of the advantages of masking tape is that it does not leave any residue after it has been removed. Different types of masking tape are known, mainly single-faced tape and double-faced tape. Double-faced tape allows for sheets of masking material to be applied to a second side after the first side has been precisely applied around the area to be masked. Some known and commercially available double-faced tape has areas that are uncoated or covered with an adhesive-rejecting layer along one edge to facilitate handling while the sheet is being applied.

U.S. Pat. No. 5,098,786 to Hanke discloses a double-faced tape having two areas on each side separated by a midline, one area on each side being coated with adhesive and opposite a non-adhesive non-stick area on the other side and the other non-adhesive area on each side opposite an area coated with adhesive on the other side, the improvement wherein the tape is folded along the midline with one adhesive-coated area adhering to a non-adhesive-coated non-stick area, a narrow margin being left uncoated along at least one of the adhesive-coated areas.

While this invention is similar to the present invention in certain aspects, the present invention possesses distinct advantages over this invention and other prior art.

### SUMMARY OF THE INVENTION

Double-faced masking tape is disclosed according to an embodiment of the present invention. The tape has two areas on each side, one area on each side being coated with adhesive and opposite a non-adhesive non-stick area on the other side and the other non-adhesive area on each side opposite an area coated with adhesive on the other side. The two areas on each side are separated by a non-adhesive gaphaving a widthbetween ⅛″ and 3″. The non-adhesive gap allows for a certain margin of error as the tape is being rolled during manufacture, preventing the adhesive areas on opposite sides of the tape from coming in contact with one another. The preferred width of the double-faced tape is between ½″ and 4″.

### BRIEF DESCRIPTION OF THE DRAWINGS

Further features of the inventive embodiments will become apparent to those skilled in the art to which the embodiments relate from reading the specification and claims with reference to the accompanying drawings, in which:

FIG. 1 shows one side of a strip of double-faced tape,

FIG. 2 shows another side of a strip of double-faced tape,

FIG. 3 shows a roll of double-faced tape.

### DETAILED DESCRIPTION OF THE DRAWINGS

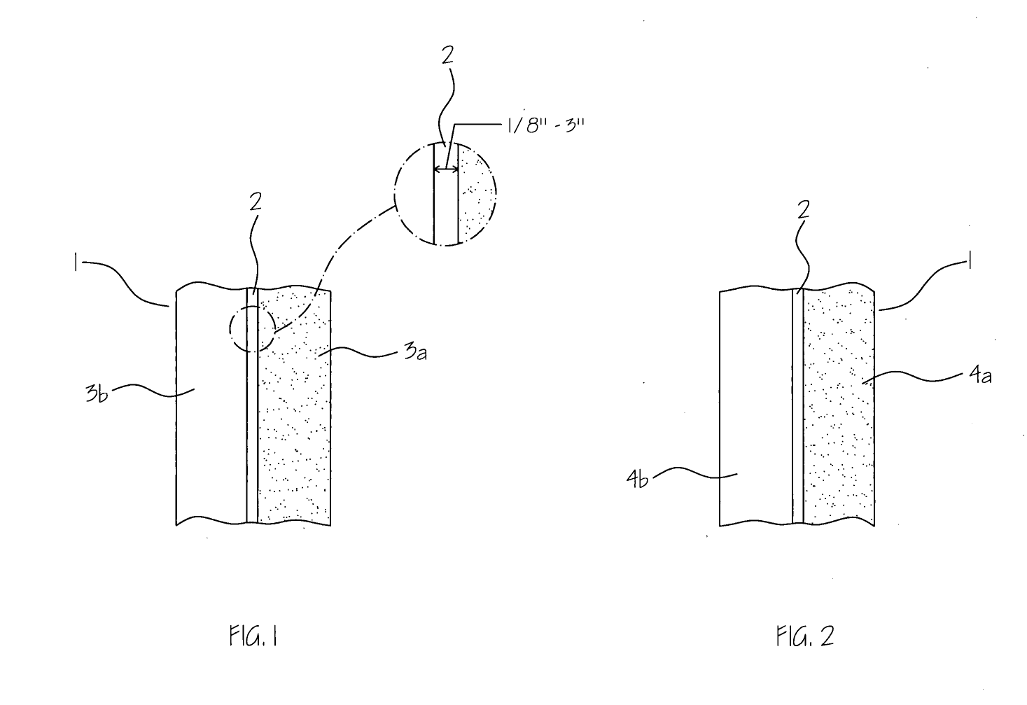

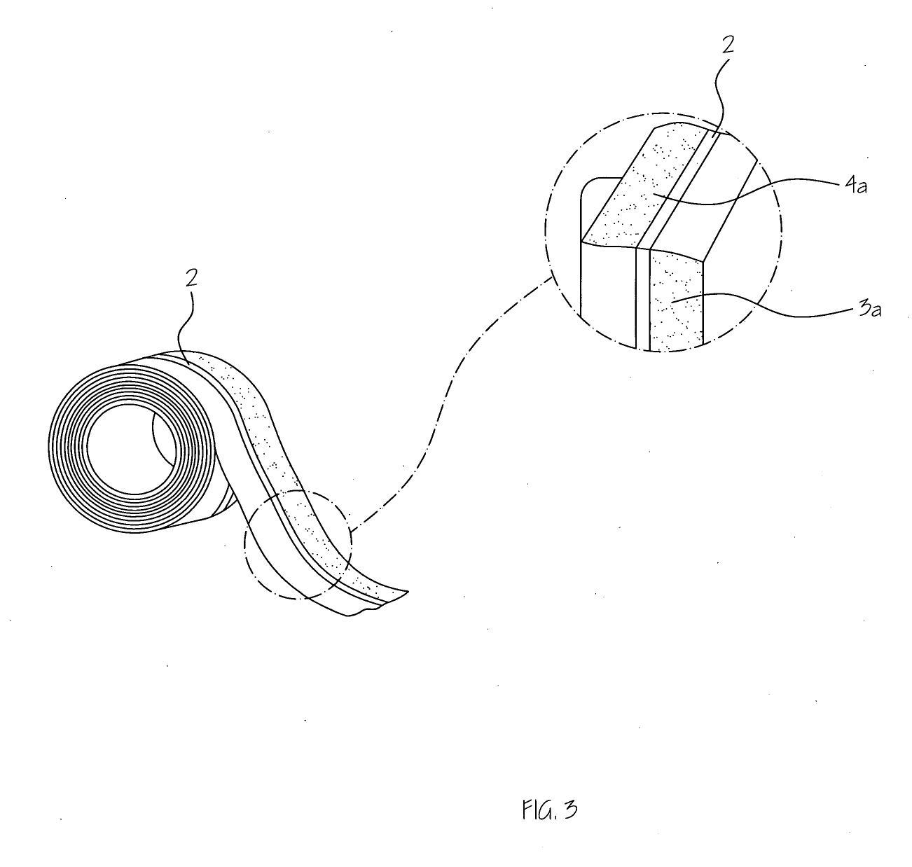

Referring now to FIGS. 1 and 2, the tape 1 in accordance with the invention is partly coated on each side with adhesive. Each side is divided by a gap 2 into two areas 3a and 3b or 4a and 4b. Each area 3a and 4a is coated with adhesive, while its adjacent area 3b and 4b is coated with a non-adhesive substance. Each adhesive-coated area 3a and 4a has a non-adhesive-coated area 3b and 4b directly behind it on the opposite side of the tape.

The gap 2 is coated with a non-adhesive substance and has a preferred width of ⅛″ to 3″. The tape 1 has a preferred width of ½to 4″.

Referring now to FIG. 3, a roll of tape 1 is shown. The gap 2 prevents the adhesives areas 3a and 4a from accidentally coming in contact with one another.

What is claimed is:

1. Double-faced masking tape having two areas on each side, one area on each side being coated with adhesive and opposite a non-adhesive non-stick area on the other side and the other non-adhesive area on each side opposite an area coated with adhesive on the other side, the two areas on each side being separated by a non-adhesive gap.

2. A tape as in claim 1, wherein the gap is approximately ⅛″ to 3″ wide.

3. A tape as in claim 1 having a width between 0.5″ and 4″.
